(19) United States
(12) Patent Application Publication
(10) Pub. No.: US 2018/0183998 A1
(43) Pub. Date: Jun. 28, 2018

(54) POWER REDUCTION AND PERFORMANCE IMPROVEMENT THROUGH SELECTIVE SENSOR IMAGE DOWNSCALING

(71) Applicant: QUALCOMM Incorporated, San Diego, CA (US)

(72) Inventors: Assaf Menachem, Yokneam (IL); Pia Zobel, Hinanlt (IL)

(21) Appl. No.: 15/388,118

(22) Filed: Dec. 22, 2016

(51) Int. Cl. H04N 5/232; G06K 9/62; H04N 5/347; G06T 5/00; G06T 5/20; G06T 7/194; G06T 7/11

(52) U.S. Cl. CPC H04N 5/23232; G06K 9/6267; H04N 5/347; G06T 5/003; H04N 5/369; G06T 7/194; G06T 7/11; G06T 5/007; G06T 5/20

(57) ABSTRACT

Methods and systems for reducing power by controlling a sensor to selectively downscale portions of generated image signals representing a target scene image, the downscaled portions corresponding to identified portions of a previously processed captured and image also representative of the target scene. One innovation includes an imaging device having an image sensor having an array of imaging elements, the image sensor configured to generate first image information of a first spatial resolution for first portions of the array of imaging elements, and generate second image information for one or more second portions of the array of imaging elements, the second image information having one or more second spatial resolutions that are downscaled relative to the first spatial resolution, the image sensor further configured to control the downscaling of the one or more second resolutions by received downscaling control information identifying portions of the array of imaging elements.

### TECHNICAL FIELD

The systems and methods disclosed herein are directed to reducing power in an imaging sensor, and more particularly, to controlling a sensor to selectively downscale certain portions of the sensor based on classification and segmentation of subject-free areas of an image.

### BACKGROUND

Today, video capture processes and hardware is being pushed to the edge with high-resolutions and high frame-rates in stand-alone imaging systems and cameras that are included on mobile device, e.g., cell phones and tablets. As high-resolution resolution sensors that are used in such imaging systems/devices continue to increase to 16 megabytes and above for both video and still pictures, corresponding higher-end image processors are needed to effectively support the processing of the high through-put of such applications, and this can cause the system-on-chips (SOCs) preforming this processing to generate an undesired level of heat and cause large power consumption.

Providing less data from a sensor by downscaling can reduce heat generation. Downscaling at the sensor generally refers to forming groups of pixels to reduce the resolution of an image, or a portion of an image, and thus forming a smaller image that maybe easier to process or transmit. An imager may be configured to perform pixel binning on captured images. Pixel binning may be performed by forming groups of pixels and combining sampled values from the pixels in each group. The sampled values from the pixels may be combined by assigning weights to each pixel, scaling the sampled values by the corresponding weights, and summing the scaled values. The groups of pixels and pixel weights may be selected to produce binned images with even spatial distribution. The pixel binning operation may be performed by processing circuitry that receives captured image data from the imager. In some embodiments, the pixel binning operation may also be separated into a horizontal binning step and a vertical binning step that are performed by image readout circuitry during image readout. During the horizontal binning step, pixels of a particular row may be combined. During the vertical binning step, pixels of particular columns may be combined. Accordingly, intelligent use of downscaling techniques may be advantageous so that SOCs produce less heat and a device's power consumption is reduced.

### SUMMARY

In general, this disclosure is related to systems and techniques for simultaneously power reduction and performance improvement through selective sensor downscaling. Certain aspects of embodiments of systems and methods are disclosed herein. The one or more aspects may be included in various embodiments of such systems and methods. In addition, certain embodiments of the disclosed systems and methods may not include one or more of the disclosed aspects.

One innovation includes an imaging device including an image sensor having an array of imaging elements and readout circuitry for generating image information of a target scene, the image information comprising at least first and second image information. In some embodiments, the image sensor is configured to generate first image information of a first spatial resolution, the first image information including image data corresponding to a pixel values generated by a first portion of the array of imaging elements, and generate second image information of a second spatial resolution, the second image information including image data corresponding to pixel values generated by a second portion of the array of imaging elements, the second spatial resolution being less than the first spatial resolution, the image sensor being further configured to control the downscaling of the spatial resolution of portions of the array of imaging elements responsive to received downscaling control information. The system may also include a memory component, and a processor coupled to the memory component, the processor configured to receive an image of the target scene and classify content of the image based on predetermined criteria to identify candidate portions of the image for downscaling, determine downscaling control information for the candidate portions that for controlling downscaling of an image generated by the image sensor, and provide the downscaling control information to the image sensor.

Some other aspects of embodiments of such systems are disclosed below. In some embodiments, the image received by the processor is based on image data in the first image information and the second image information generated by the image sensor. The second image information may include meta-data identifying the downscaling of the image data in the second image information. The image sensor may be further configured to control downscaling of the second image information using the downscaling control information. In some embodiments, the image sensor is configured to perform vertical binning to generate the second image information responsive to the downscaling control information. The imaging device may further include an image processor in electronic communication with the image sensor and the processor, and the image processor may be configured to receive the first and second image information from the image sensor, upscale the image data in the second image information, and provide the image to the processor. In one aspect, the image information includes meta-data identifying the downscaling performed by the image sensor, and wherein the image processor is configured to upscale the image data in the second image information based on the meta-data. In another aspect, the image processor is in electronic communication with the processor, and wherein the image processor is configured to receive an IP control input from the processor and upscale the image data in the second image information based on the IP control input. In another aspect, the image processor comprises one or more filters configured to upscale the image data in the second image information. The processor may be further configured to provide an IP control input to the image processor, the IP control input identifying image processing operations for the image processor to perform on image data received from the image sensor.

In some embodiments, the image processor is configured to, responsive to the IP control input, downscale portions of image data received from the image sensor and subsequently upscale the downscaled portions. In some embodiments, the IP control input includes information that identifies portions of image data to upscale. The predetermined criteria used to determine candidate portions of an image of the target scene may include a dynamic range threshold value to identify portions of the content of the image that have a small range of pixel values. The predetermined criteria may include a sharpness threshold to identify portions of the content of the image that includes un-sharp pixel values. The predetermined criteria may include a contrast threshold to identify portions of the content of the image that includes pixel values indicative of out-of-focus image data content. The predetermined criteria may include a contrast threshold for identifying subject and background portions of the content of the image.

Another innovation is a method of processing image data, the method including receiving, by an electronic hardware processor, an image of a target scene that is generated at least in part by an image sensor, classifying, by the electronic hardware processor, content of the image based on predetermined criteria to identify candidate portions of the target scene for downscaling, generating, by the electronic hardware processor, downscaling control information that identifies one or more of the candidate portions of the target scene for downscaling by the image sensor, communicating the downscaling control information from the electronic hardware processor to the image sensor, and generating image information of the target scene by the image sensor based on the downscaling control information, the image information comprising first image information of a first spatial resolution, the first image information including image data corresponding to pixel values generated by a first portion of the array of imaging elements, and second image information of a second spatial resolution, the second image information including downscaled image data corresponding to pixel values generated by a second portion of the array of imaging elements, the second spatial resolution being less than the first spatial resolution.

In such methods, the image of the target scene received by the processor may be based on image information generated by the image sensor. In some embodiments, the second image information includes meta-data identifying the downscaled image data in the second image information. In some embodiments, generating the image information includes performing vertical binning to generate the second image information. Some embodiments of such methods further include receiving, at an image processor, the first and second image information from the image sensor, upscaling the image data in the second image information at the image processor, and providing, from the image processor, the image of the target scene to the electronic hardware processor. In some aspects of embodiments of such methods, the image information includes meta-data identifying downscaling performed by the image sensor, and wherein upscaling the image data in the second image information is based on the meta-data. In some aspects of embodiments of such methods, the image processor is in electronic communication with the electronic hardware processor, and the method further comprises receiving at the image processor an IP control input from the electronic hardware processor, and upscaling the image data in the second image information based on the IP control input. In some aspects, the IP control input includes information that identifies portions of a target scene to image data to upscale. In some aspects, at the image processor and responsive to the IP control input, downscaling portions of the image information image and subsequently upscaling the downscaled portions. In some aspects, the predetermined criteria includes at least one of a dynamic range threshold value for identifying portions of the content of the image that have a small range of pixel values, contrast threshold for identifying portions of the content of the image that includes pixel values indicative of out-of-focus image data content, or a sharpness threshold for identifying portions of the content of the image that includes un-sharp pixel values. Some embodiments of such methods further comprise generating the image data of the second image information by performing vertical binning on the image sensor.

Another innovation includes a non-transitory computer readable medium comprising instructions that when executed cause an electronic hardware processor to perform a method of image collection at an image sensor, the method including receiving, by the electronic hardware processor, an image of a target scene that generated at least in part by an image sensor comprising an array of imaging elements, classifying, at the electronic hardware processor, content of the received image based on predetermined criteria to identify candidate portions of the target scene for downscaling, generating, by the electronic hardware processor, downscaling control information that identifies one or more of the candidate portions of the target scene for downscaling by the image sensor, and communicating the downscaling control information from the electronic hardware processor to the image sensor for use by the image sensor to capture image information of the target scene, the image information including first image information of a first spatial resolution, the first image information including image data corresponding to pixel values generated by a first portion of the array of imaging elements, and second image information of a second spatial resolution, the second image information including downscaled image data corresponding to pixel values generated by a second portion of the array of imaging elements, the second spatial resolution being less than the first spatial resolution. In some embodiments, the method further includes generating an IP control input at the electronic hardware processor and providing the IP control input to an image processor, the IP control input including information for use by the image processor to upscale the image data of the second image information.

Another innovation is a method of processing image data, the method including receiving, at an electronic hardware processor from an image processor, an image of a target scene that was captured by an image sensor, classifying, by the electronic hardware processor, content of the image based on predetermined criteria to identify portions of the target scene for downscaling, generating, by the electronic hardware processor, downscaling control information that indicates one or more portions of the target scene for downscaling by the image sensor, providing the downscaling control information to the image sensor, generating, by the image sensor, image information of the target scene based on the downscaling control information, the image information includes first image information of a first spatial resolution, the first image information including image data corresponding to pixel values generated by a first portion of the array of imaging elements, and second image information of a second spatial resolution, the second image information including downscaled image data corresponding to pixel values generated by a second portion of the array of imaging elements, the second spatial resolution being less than the first spatial resolution. The method further includes providing the image information to the image processor; and upscaling the image data of the second image information, at the image processor.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIG. 1A is a schematic illustrating an example of an embodiment of a power reduction system for an image sensor.

FIG. 1B is a schematic illustrating an example of imaging elements configured in an array of an image sensor and control/readout circuitry, according to some embodiments.

FIG. 2 is a block diagram illustrating an example of an imaging device implementing some operative embodiments.

FIG. 3 illustrates an image that depicts a prominent subject (a man) generally centered in the foreground of the image, and background imagery behind the subject.

FIG. 4 illustrates an image that depicts a prominent subject (a woman) generally centered in the foreground of the image, and “flat” background imagery (having a low dynamic range) behind the subject.

FIG. 5 illustrates an image that depicts a subject (a bouquet of roses) positioned in the left and center portion of the image and in the foreground of the image, and out-of-focus imagery in the background imagery behind the subject.

FIG. 6 is a representation of the area of the image shown in FIG. 3, illustrating segmentation and classification of the image into a subject portion and a background portion, the background portion characterized by certain image characteristics, for example, having a smaller dynamic range than the subject portion and/or being more out-of-focus (less sharp) than the subject portion.

FIG. 7 is a representation of the area of the image shown in FIG. 4, illustrating segmentation and classification of the image into a subject portion and a flat portion, the flat portion characterized by having a dynamic range that is less, or substantially less, than the subject portion.

FIG. 8 is a representation of the area of the image shown in FIG. 5, illustrating segmentation and classification of the image into a subject portion and an out-of-focus portion, the out-of-focus portion of the image characterized by smoother edge transitions in the image.

FIG. 9 illustrates an example of rectangular areas covering most of the background portion of the image illustrated in FIG. 3, the rectangular areas representing portions of the background which may be determined to be downscaled, and which control information is provided to the image sensor to downscale image data that is captured by the image sensor by sensing elements on the sensor corresponding to the rectangular areas.

FIG. 10 illustrates an example of rectangular areas covering most of the background portion of the image illustrated in FIG. 4, the rectangular areas representing portions of the background which may be determined to be downscaled, and which control information is provided to the image sensor to downscale image data that is captured by the image sensor by sensing elements on the sensor corresponding to the rectangular areas.

FIG. 11 illustrates a process for reducing power of an imaging device, according to one embodiment.

### DETAILED DESCRIPTION

The systems and methods disclosed herein are directed to reducing power in an imaging sensor, for example, controlling a sensor to selectively downscale certain portions of the sensor based on classification and segmentation of subject-free areas of an image.

There has been a trend with the latest generation image sensors to increase resolution while also reducing the pixel size at the expense of some other performance parameters. Controlled downscaling of an image sensor may increase the performance of a video or still camera system machine by reducing the thermal energy produced and lowering bandwidth requirements. Binning is one example of downscaling. If you do not need all of the resolution provided in some portions of an image, then binning is an easy solution.

In some embodiments, binning may be performed by adding the charge of two or more pixels together. The charge in a target pixel then represents the illumination of the two or more pixels, that is, the photons received by the two or more pixels. In some embodiments, pixels may be binned vertically by shifting two image rows into the horizontal register without reading it after the first shift. In some embodiments, pixels may be binned horizontally by shifting the horizontal register two times into output node without resetting it after the first shift. Due to the architecture of most (if not all) sensors, horizontal binning cannot be done on the image sensor, and is instead performed in image sensor readout circuitry, or may be performed downstream during image processing operations, for example, performed by an image processor. Vertical binning, however, can be done on the sensor level. With vertical binning, the charge of multiple lines may be combined in the sensor before they are readout. For example, for a vertical binning of four lines (e.g., rows) of image data, a vertical shift (or transport) and summing of four lines occurs and then a horizontal transport of this binned line takes place. Then, the cycle of vertical shift of more four lines and horizontal readout starts again and repeats.

Combining of both vertical and horizontal binning results in square (or rectangular) image binning. For example, 2×2 binning is a combination of 2× vertical and 2× horizontal binning. One advantage of binning is higher signal-to-noise ratio (SNR) due to reduced read noise contributions and increased signal combinations. CCD read noise is added during each readout event and in normal operation, read noise will be added to each pixel. However, in binning mode, read noise is added to each super pixel, which has the combined signal from multiple pixels. In the ideal case, this produces SNR improvement equal to the binning factors. With binning you can increase pixel size arbitrarily (but reduce the spatial resolution). In the limit we could even read out the CCD as a single large pixel.

Binning also increases frame rate. Since the slowest step in the readout sequence is usually the digitization of a given pixel, binning can be used to increase the effective total frame rate of a given system. Thus, highly “binned” lower-resolution images can be obtained when a high speed frame rate is desired. By selectively downscaling subject-free, or non-important, parts of an image, an imaging system may decrease the amount (payload) of image data produced while maintaining quality in regions of interest. In some embodiments, the images are downscaled by vertical binning at the sensor and horizontal at the sensor (e.g., using the readout circuitry) before the data is communicated to an image processor. In other embodiments, further downscaling is performed by an image processor which receives image information from the sensor, the image information received having been vertically binned at the sensor. Based on the history of the image data being produced (for example, as provided to the viewfinder for still images, and one-or-more previous frames for video), one may detect the areas of the image that may be characterized as non-important. For example, areas of the image that are flat, out-of-focus, and/or far/background areas may be detected using various image processing techniques. For example, determining one or more portions of an image that has a dynamic range below a certain threshold value (flat image data), determining one or more portions of an image that have edge transitions below a certain threshold, that is, unsharp edges (out-of-focus image data), and/or determining one or more portions of an image that is background information (for example, by detecting sharp portions and un-sharp surrounding sharp portions, the unsharp portions being different than the sharp portions by a certain threshold value). Instructions for downscaling these “unimportant” areas can be passed to the sensor and be applied in the sensor to control binning, and/or this information may be supplied to an image processor to control downscaling (e.g., binning). This will effectively lead to less pixels being processed in the image chain from the sensor to (and thru at least some portions of) the image processor, thus saving significant power and increasing performance. Subsequently, the image processor, having the information of where downscaling may have occurred, may upscale the image data in the previously downscaled portions of the images (and other portions if desired) and still images or video may be provided at a desired resolution.

When performing the downscaling in the sensor, one gains additional benefits due to smaller bandwidth of the sensor-image processor interface. In some embodiments, horizontal binning may only be performed due to the rolling shutter. The ability to apply vertical binning, in the scenario of rolling shutter, may be dependent on the shake frequency. For example, vertical binning in case of high frequency shakes will cause blur and artifacts. If handled in the ISP, this can be avoided through proper processing. As in some implementations, when performing the downscaling in the front end image processor, one gains the ability to apply both horizontal and vertical downscaling, which can improve quality.

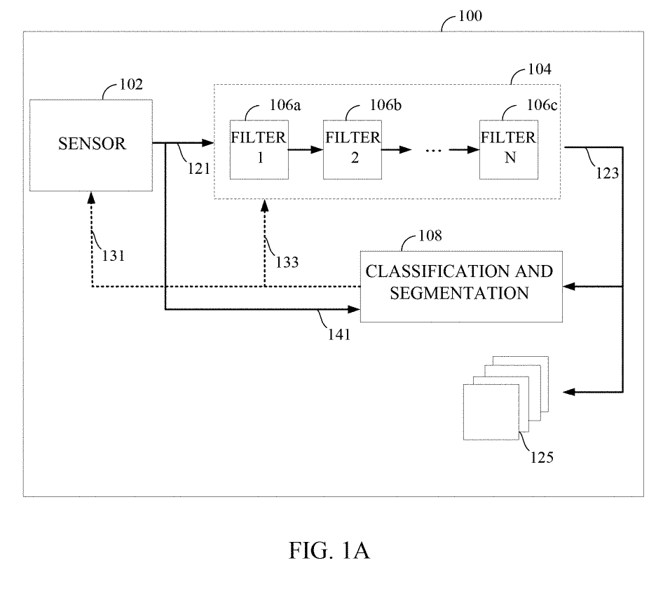

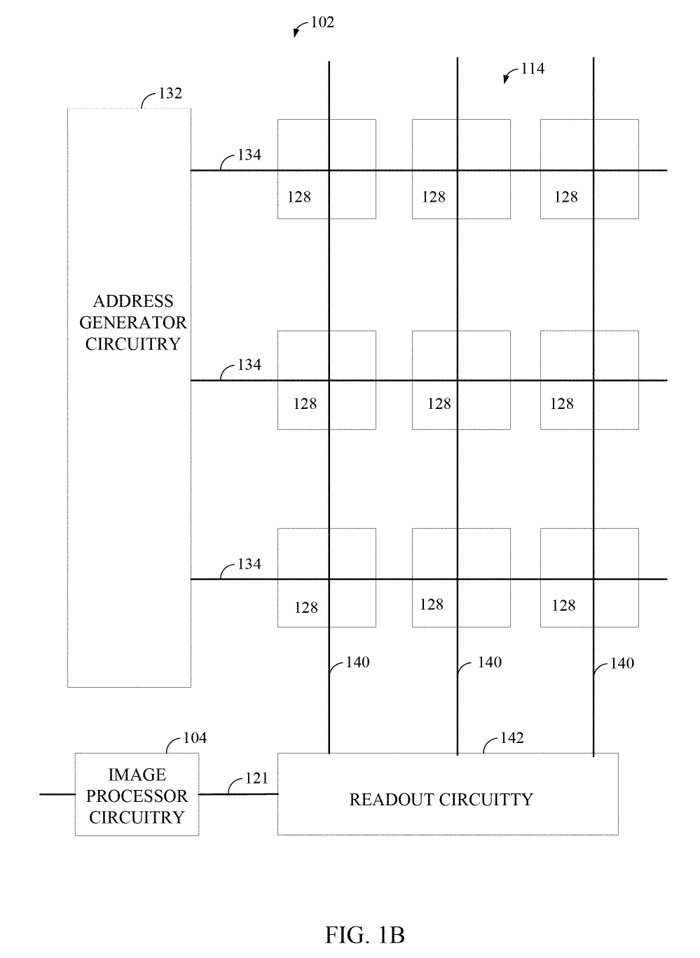

FIG. 1A is a schematic illustrating an example representing an embodiment of a power reduction system 100. Embodiments of a power reduction system 100 may include an image sensor 102 and an image processor 104. The image sensor 102 may include an array of electronic imaging elements, for example, disposed in an imaging plane, and the array may include millions or tens of millions (or more) of imaging elements. Each imaging element is configured to receive incident light (e.g., photons) and generate a signal based on the light incident on the imaging element. The image sensor 102 may be, for example, a CMOS or CCD sensor, or another type of image sensor. The image processor 104 is coupled to, and in electronic communication with, the image sensor 102, and may receive image information 121, from the image sensor 102, of a target scene captured by the image sensor 102. In some embodiments, the power reduction system 100 may include, or be incorporated into, a standalone camera, a mobile device or a cell phone having a camera, a camera module, medical imaging equipment, night vision equipment such as thermal imaging devices, radar, sonar, and others configurations of computers (e.g., laptops, tablets, etc.). Such a power reduction system 100 may be used an imaging system to reduce power consumption. In particular, the power reduction system 100 maybe used in imaging systems that have one or more high resolution sensors (e.g., ones that include an array of 1 MB-2826 MB+ imaging elements, sometimes generally referred to as “sensels” or “pixels”). In addition, the same or similar components and functionality may be included in systems that have lower resolution sensors (for example, 0.01-1 MB). For example, in imaging systems where bandwidth may be limited or expensive to implement, e.g., orthoscopic medical imaging devices, small imaging systems, laryngoscopy imaging systems, imaging systems implemented on drones, or other remote or wirelessly connected imaging systems where bandwidth to communicate image data may be limited.

The example power reduction system 100 illustrated in FIG. 1A shows certain components and data flows that are related to the operation of the system 100, which can lower power consumption by downscaling digital images captured by the sensor 102. As a person of ordinary skill in the art will appreciate, other components may also be included in the system 100 but are not illustrated for clarity of FIG. 1. These components may include, but are not limited to, a lens assembly, one or more apertures, control circuitry for transferring the signals generated by the image sensor 102 to the image processor 104, or electronic storage (memory). Such components may be included in embodiments of the invention without departing from the scope of this disclosure. Some components of a power reduction system 100 not illustrated in the example shown in FIG. 1A are illustrated in, and described in reference to, FIG. 2.

The image information 121 communicated from the image sensor 102 to the image processor 104 may include image data, for example, data that represents the signal information generated by the array of imaging elements of the image sensor 102 from light received from a target scene. The image information 102 may also include metadata that includes information of downscaling performed by the image sensor. For example, the metadata may include information that identifies a portion, or portions, of the image data as being downscaled (or not downscaled) by the image sensor 102, and indicate how it was downscaled, e.g., horizontally, vertically and/or to what extent: 2×, 3× 4×, 5×, 6×, 7×, 8×, 16×, 32×, etc. Note: the downscaling ratio does not have to be a factor of two. The metadata in the image information 121 is received by the image processor 104, and may be used by the image processor to upscale the previously downscaled portions of the image, or perform some other type of image processing operation on certain portions of the image data received in the image information 121. The metadata may include: (1) the scaling information, for example, block size and location, scaling factor, downscaling method (e.g., vertical and/or horizontal, bilinear, bicubic, or another method); (2) classifier and segmentation results; and (3) information regarding any processing done by the image sensor (e.g., the sensor chip) or done by filters preceding the image processor 104.

The image processor (or “media processor”) 104 may be a specialized digital signal processor (DSP) used for image processing applications in digital cameras, mobile phones or other devices. The image processor 104 may employ parallel computing with single instruction, multiple data (SIMD) or multiple instruction, multiple data (MIMD) technologies to increase speed and efficiency through processing using a number of processors that function asynchronously and independently. At any time, different processors may be executing different instructions on different pieces of data. The digital image processing engine can perform a range of tasks. In some embodiments, to increase the system integration on embedded devices, the image processor 104 maybe a system on a chip (SOC) with multi-core processor architecture.

The image processor 104 may include one or more filters 106a-c that are configured to perform image processing operations on image information 121 received from the image sensor 102, for example, the image processor operations may include filtering. The filters 106a-c can be configured in hardware, software, or a combination of hardware and software. “Filters” in this context is used to generally refer to a way of processing image data to change an aspect of the image data. For example, one or more of the filters 106a-c may be configured to downscale or upscale one or more portions of received image data, or all of the image data. The one or more of the filters 106a-c may also be configured to perform a variety of other image processing functionality on image data including, for example, low pass filtering, high pass filtering, median filtering, reconstruction filtering, and/or image enhancement filtering (changing dynamic range, brightness, contrast, or color). The image information 121 may include metadata and image data. The image data can include information representative of the light received by each imaging element in the image sensor when a target scene is captured. One or more portions of the image data may be downscaled image data, for example, that was downscaled by the image sensor 102 by vertical binning. In some embodiments, the metadata identifies portions of the image information that was downscaled by the image sensor 102. The metadata may be used by the image processor 104 to control the one or more filters 106a-c to perform downscaling of the image data, or to determine what portions of the image data should be upscaled because they were previously downscaled.

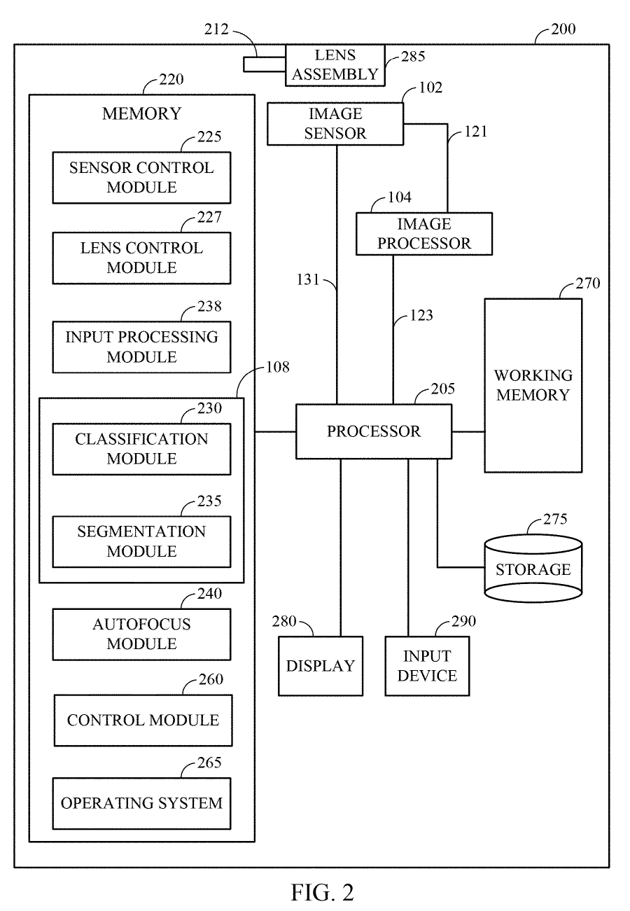

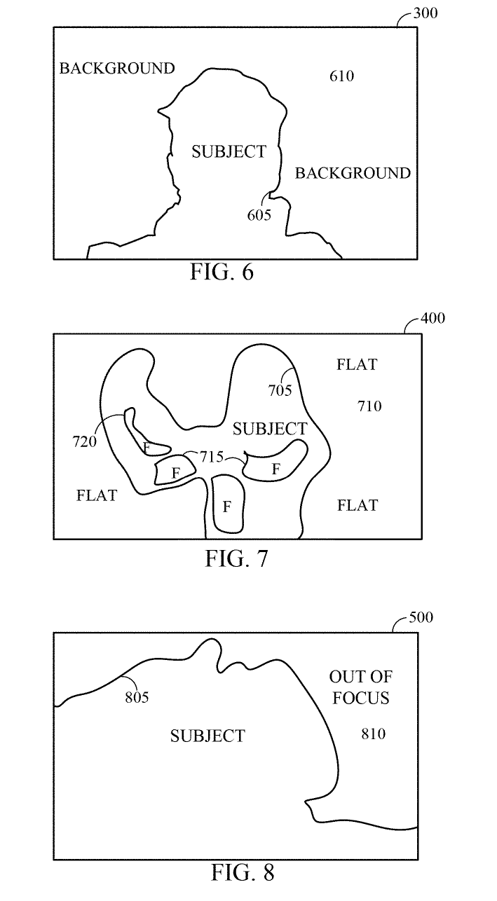

The power reduction system 100 also includes a classification and segmentation module 108 that may directly or indirectly receive image data from the sensor 102. The classification and segmentation module 108 may be configured to classify one or more portion of an image of the image data. In some embodiments, the classification and segmentation module 108 classifies one or more portions of the image data to be a particular category, for example, a subject portion, a background portion, an out-of-focus portion, a “flat” portion, and/or another “non-important” portion of the image. For example, an unimportant portion of the image may be a portion that is not as important as an identified subject portion of the image). The classification and segmentation module 108 also may determine segmentation information for the classified one or more portions of the image data, the segmentation information indicating which portion of an image should be segmented. Some representative examples of classifying and segmenting an image are illustrated in FIGS. 6, 7, and 8, for the example images that are illustrated in FIGS. 3, 4, and 5, respectively. In various embodiments, the classification and segmentation module 108 may be implemented in the same component as the image processor 104, or as a separate component on another processor(s). Some embodiments may include a configuration where the image processor 104, the classification and segmentation module 108, and a general purpose processor 105 (FIG. 2) are implemented on the same integrated circuit or SOC. In various embodiments, the functionality for classifying image data and segmenting image data is implemented in two (or more) different modules, instead of the single classification and segmentation module 108 illustrated in FIG. 1. The example of the classification and segmentation module 108 is illustrated in FIG. 1A as receiving an image processor (IP) output 123 of the image processor 104 that includes image data. In some embodiments, alternatively the classification and segmentation module 108 receives image data 141 from the sensor 102 that does not pass through the image processor 104, and processes the content of the received image data for classification and segmentation, as described herein. The image processor 104 may also provide output image data 125 that can be provided to a display (e.g., display 280 FIG. 2) or a storage medium (e.g., storage 275 FIG. 2).

Still referring to FIG. 1, in some embodiments the classification and segmentation module 108 is configured to provide a control signal 131 to the image sensor 102 that controls the image sensor 102 to downscale one or more portions of image data captured by the image sensor 102, based on the classifications and segments determined by the classification and segmentation module 108. For example, for video image data, where a sequence of “frames” (images) of a target scene are captured by the image sensor 102 at many frames per second in a video stream (e.g., at 24 FPS or 30 FPS), the classification and segmentation module 108 may classify at least one portion (or a plurality of portions) of a captured frame as including a subject and classify another portion (or a plurality of portions) of the captured frame as including background imagery, is out-of-focus, and/or has a low dynamic range (e.g., is “flat”), and/or includes another image characteristic that indicates that a portion is less important than the portion of the image that includes the subject. The classification and segmentation module 108 may determine the classification by processing a single frame, or by processing a plurality of frames, in accordance with various embodiments. The classification and segmentation module 108 then may determine segment information that represents identified portions of the image that can be downscaled without losing too much image detail. This segment information (or “downscaling control information”) can be provided to the image sensor 120 as a control input 131, and the image sensor 102 in response to the control input 131 may perform downscaling of the identified portion(s) of the image.

The classification and segmentation module 108 may also provide a IP control input 133 to the image processor 104. The IP control input 133 may include information that the image processor 104 uses to upscale images that were downscaled by the image sensor 104. For example, in some embodiments an IP control input 133 may include information to identify which portions of the image data was downscaled by the image sensor 102, similar to the information discussed in reference to FIG. 9 that is provided as a control input 131 to the image sensor 102. In some embodiments, the IP control input 133 may include information that controls the image processor 104 to perform downscaling and/or upscaling. For example, the IP control input 133 may identify the determined unimportant portions of the image data (e.g., background, out-of-focus areas, non-subject areas, areas having low dynamic range, etc.) that the image processor 104 may in an earlier stage of image processing, in response to the IP control input 133, downscale the unimportant areas of the image data and then at a subsequent processing step (that is, later in the image processing that is performed by the image processor 104) upscale the image data to a desired resolution in order to save processing time and power. The classification and segmentation module 108 is further described in reference to FIG. 2.

FIG. 1B is a schematic illustrating an example of imaging elements configured in an array 114 of the image sensor 102 of FIG. 1A and control/readout circuitry, according to some embodiments. As shown in FIG. 1B, imaging elements 128 of the array 114 are coupled to image readout circuitry 142 and address generator circuitry 132. As an example, each of the imaging elements 128 in a row of the array may be coupled to address generator circuitry 132 by one or more conductive lines (or paths) 134, and to readout circuitry 142 by one or more conductive lines 140. Array 114 may have any number of rows and columns. In general, the size of array 114 and the number of rows and columns in array 114 will depend on the particular implementation. For example, the number of rows and columns may be sized to form an array 114 of 5 million, or 10 million, or 16 million imaging elements, or more. While rows and columns are generally described herein as being horizontal and vertical rows and columns may refer to any grid-like structure (e.g., features described herein as rows may be arranged vertically and features described herein as columns may be arranged horizontally).

Address generator circuitry 132 may generate signals on paths 134 as desired to control the functionality of imaging elements 128. For example, address generator circuitry 132 may generate reset signals on reset lines in paths 134, transfer signals on transfer lines in paths 134, and row select (e.g., row readout) signals on row select lines in paths 134 to control the operation of array 114. In some embodiments, address generator circuitry 132 and array 114 may be integrated together in a single integrated circuit.

Image readout circuitry 142 may include sample and hold circuitry, analog-to-digital converter circuitry, and line buffer circuitry, as examples. Image data from the image readout circuitry 142 may be provided to the image processor 104. As one example, circuitry 142 may be used to measure signals in imaging elements 128 and may be used to buffer the signals while analog-to-digital converters in circuitry 142 convert the signals to digital signals. In a typical arrangement, circuitry 142 reads signals from rows of imaging elements 128 one row at a time over lines 140. The digital signals read out by readout circuitry 142 may be representative of charges accumulated by imaging elements 128 in response to incident light. The digital signals (image information) 121 produced by the analog-to-digital converters of circuitry 142 may be conveyed to image processor circuitry 104, and may include image data and metadata.

FIG. 2 is a block diagram illustrating an example of a power reduction system that is implemented with an imaging system in a device 200, according to some embodiments. That is, both the functionality of the imaging system and the power reduction system are housed in the same device 200. Such a device can be a cell phone, a tablet computer, any type pf a mobile device, or a standalone camera (that is, a camera that does not include all of the typical smart-phone functionality, but may include certain aspects such as communication components and functionality. For ease of reference with respect to FIG. 2, the imaging system and power reduction system of the device 200 are referred to collectively as the imaging system 200. The imaging system 200 may include an electronic hardware processor 205 that is operatively connected to an image sensor 102, an electronic working memory 270, an electronic storage 275 (for example, electronic storage of a greater capacity than the working memory storage 270), a display 280, and an input device 290. In addition, processor 205 is connected to an electronic memory 220. In this example, the memory 220 stores a plurality of operating modules that store data values defining instructions to configure processor 205 to perform functions relating to the imaging system 200. In some embodiments, some or all of these functions may be implemented in software, hardware, or a combination of hardware and software. In this example, the memory 220 includes a sensor control module (or sensor controller) 225, a segmentation and classification module 108 that includes a classification module 230 and a segmentation module 235. The memory 220 also includes an autofocus module 240 which controls an actuator 212 coupled to a lens assembly 285 through which light is received from a target scene and is directed to form an image on the image sensor 102. The memory further includes an operating system 265 for the imaging system 200, including operations of the power reduction functionality. Other modules that control other aspects of the imaging system 200 may also be included in the memory 220.

When capturing target scenes, light enters the lens assembly 285 and is focused on the image sensor 102. In some embodiments, the lens assembly 205 is part of an autofocus lens system which can include multiple lenses and adjustable optical elements. In one aspect, the image sensor 102 utilizes a CMOS or CCD sensor. The lens assembly 285 is coupled to the actuator 212, and is moved by the actuator 212 relative to the image sensor 102. The actuator 112 is configured to move one or more optical elements of the lens assembly 205 in a series of one or more lens movements during an AF operation, for example, adjusting the lens position to change the focus of an image on the image sensor 102.

The display 280 is configured to display images captured by the image sensor 102 and may also be configured to be an user interface of the imaging system 200. In one implementation, display 280 can be configured to display one or more objects selected by a user, via an input device 190, which maybe a touchscreen incorporated on the display 280, of the imaging system 200. In some embodiments, the imaging system 200 may not include the display 280.

The input device 290 may take on many forms depending on the implementation. In some implementations, the input device 290 may be integrated with the display 280 so as to form a touch screen display. In other implementations, the input device 290 may include separate keys or buttons on the imaging system 200. These keys or buttons may provide input for navigation of a menu that is displayed on the display 280. In other implementations, the input device 290 may be an input port. For example, the input device 290 may provide for operative coupling of another device to the imaging system 200. The imaging system 100 may then receive input from an attached keyboard or mouse via the input device 290. In still other embodiments, the input device 290 may be remotely located device and communicate with the imaging system 200 over a communication network, e.g., a wireless network.

The working memory 270 may be utilized by the processor 205 to store data dynamically created during operation of the imaging system 200. For example, instructions from any of the modules stored in the memory 220 (discussed below) may be stored in working memory 270 when executed by the processor 205. The working memory 270 may also store dynamic run time data, such as stack or heap data utilized by programs executing on processor 205. The storage 275 may be utilized to store data created by the imaging system 100. For example, images captured via image sensor 102 may be stored on storage 275. Like the input device 290, the storage 275 may also be located remotely, i.e., not integral with the imaging system 200, and may receive captured images via the communication network.

The memory 220 may be considered a computer readable media and stores several modules. The modules store data values defining instructions for processor 105. These instructions configure the processor 205 to perform functions of imaging system 200. For example, in some aspects, memory 220 may be configured to store instructions that cause the processor 205 to perform method 200, or portions thereof, as described below and as illustrated in FIG. 2. In the illustrated embodiment, the memory 220 includes a control module 160, sensor control module 225, a classification module 230, a segmentation module 235, an autofocus module 240, and an operating system 165.

In another aspect, the lens control module 227 can include instructions that configure the processor 205 to receive position information of optical elements of the lens assembly 285, along with other parameters that may be used to move the lens assembly 285. Lens position information may include the current position of the lens, and the processor 205 may provide signals to the actuator 212 to position optical elements of the lens assembly in a desired position, for example, at a desired zoom level, at a desired focus position, or in a rest or standby position. In some aspects, instructions in the lens control module 227 may represent one means for determining current lens position and moving the lens to target lens position.

The classification module 230 may include instructions that configure the processor 205 to classify portions of an image. For example, the classification module 230 may be configured to classify a portion of an image as a subject, a background, an out-of-focus area, or a “flat” area (for example, that has a low dynamic range). Image processing technologies used to perform these classifications may include various techniques that are used to distinguish portions of an image. Classification algorithms are based on the assumption that the image in question depicts one or more features, e.g., geometric parts in the case of a manufacturing classification system, or spectral regions in the case of remote sensing, and that each of these features belongs to one of several distinct and exclusive classes. The classes may be specified a priori by an analyst (as in supervised classification) or automatically clustered (e.g., as in unsupervised classification) into sets of prototype classes, where the analyst merely specifies the number of desired categories. Classification and segmentation have closely related objectives, as the former is another form of component labeling that can result in segmentation of various features in a scene. In some embodiments, an algorithm based on a convolutional neural networks is used. An illustration of their capabilities is given by the ImageNet Large Scale Visual Recognition Challenge; this is a benchmark in object classification and detection, with millions of images and hundreds of object classes. Performance of convolutional neural networks, on the ImageNet tests, is now close to that of humans. In other embodiments, other classification techniques may be used. For example, dynamic range determination, e.g., to determine “flat” portions of an image, edge detection, e.g., to determine one or more portions of an image that are out-of-focus, and a combination of dynamic range determination and edge detections, e.g., to determine a portion of an image depicting background in the image). Therefore, instructions in the classification module 230 may be one means for determining portions of an image that depict a certain type of image data, for example, a subject, background, out-of-focus imagery, and/or flat imagery. In some embodiments, the classification process may be a specific classification algorithm implemented on a processor. For example, the Snapdragon processor has a computer vision and video analytics framework that may perform face detection, object detection, flat/detail detection to classify subject, non-subject (unimportant) areas.

The segmentation module 235 includes instructions that configures the processor 205 to segment portions of the classified image into, for example, a subject portion and a background portion, a subject portion and an out-of-focus portion, or a subject portion and a “flat” portion. The functionality of classifying and segmentation may be overlapping, based on the implementation. For example, in some techniques of classifying, after classification is completed the segmentation may also be completed due to the specific technique used for classification. In other words, although classification and segmentation may generally be described as two processes, whether it is described as one process or two processes the result is the segmenting of an image into portions that have been determined to contain different subject matter, for the purpose of controlling the sensor 102 to downscale one or more certain portions of the image data to reduce the amount of data provided by the sensor, which will reduce power consumption.

The segmentation refers to identifying portions of the image that are classified as either the background portion or the subject portion. In some embodiments, the segmentation using a region growing methodology based on classification determinations. One region-growing method is the seeded region growing method. This method takes a set of seeds as input along with the image. The seeds mark each of the objects to be segmented, for example, each of the portions classified by the classification module 230. Clustering techniques can also be used for segmentation, clustering portions of an image into larger contiguous portions. While downscaling image data captured by the image sensor 102 can reduce power needed for processing, there may be detrimental performance in the image chain processing, and particularly in the downscaling on the sensor 102 and upscaling performed later in the image processor 104, if too many segments are identified each requiring control information for the downscaling and upscaling. Accordingly, the segmentation functionality may segment the image into portions of a certain minimum size. Therefore, instructions in the segmentation module 235 may be one means for determining portions of an image sensor that will be controlled to downscale image data collected from those portions of the image sensor, based on a previously determined classification of image data that was previously collected from the image sensor 102 (for example, a previous frame of a video stream of the same target scene). Various image segmentation processes (or algorithms) may be used to perform this image segmentation. In computer vision, image segmentation is the process of partitioning a digital image into multiple segments (sets of pixels). This segmentation may change the representation of an image into something that is more meaningful or useful for a specific purpose, or and easier to analyze, for example, important areas and unimportant areas. One or more of many known methods may be used to perform this segmentation, including but not limited to thresholding techniques, edge-based methods, regions-based methods, or connectivity-preserving relaxation-based segmentation methods. For example, a region-based methods may include seeded region growing, unseeded region growing, regions splitting and merging, and hierarchical clustering. In some embodiments, an unsupervised watershed algorithm can also be used. The segmentation process may be a specific segmentation algorithm implemented on a processor. For example, the Snapdragon processor has a computer vision and video analytics framework that may perform face detection, object detection, flat/detail detection to identify subject, non-subject (unimportant) areas.

The input processing module 238 may include instructions that configure the processor 205 to read input data from the input device 290. In one aspect, input processing module 238 may configure the processor 205 to detect objects within an image captured by the image sensor 102. In another aspect, input processing module 230 may configure processor 205 to receive a user input from input device 290 and identify a user selection or configuration based on the user manipulation of input device 290. Therefore, instructions in the input processing module 230 may represent one means for identifying or selecting one or more objects within an image.

The autofocus module 240 includes instructions that configure the processor 205 to determine an in-focus position of the lens assembly 285. For example, in some embodiments the autofocus module 240 includes instructions to perform auto-focus operations by determining an in-focus position of the lens assembly 285 based on determining the position of the lens assembly 285 where the contrast of images captured by the image sensor 102 is at a maximum value.

The control module 260 may be configured to control the operations of one or more of the modules in memory 220.

The operating system module 265 includes instructions that configure the processor 205 to manage the hardware and software resources of the imaging system 200.

FIGS. 3-5 illustrate example images 300, 400, and 500, respectively, of three different target scenes, and represent examples of content that may be classified and segmented by the imaging system 200 illustrated in FIG. 2. Each portion of the images 300, 400, and 500 corresponds to a portion of the sensor 102 that includes imaging elements that captured that portion of the image. The images 300, 400, and 500 respectively correspond to the example classified and segmented illustrated in FIGS. 6, 7, and 8, discussed further below.

The content of the image 300 illustrated in FIG. 3 depicts a target scene that includes a prominent subject 305 (a person) generally centered in the foreground of the image 300, and a background 310 (e.g., background imagery or background image data) behind the subject 305. In other words, a first portion of the image 300 illustrated in FIG. 3 depicts a subject 305 (the person) that is the main object of a target scene. A second portion of the image 300 depicts background imagery 310 that is not the main object of the target scene, and therefore may be considered “unimportant” or at least not as important as the first portion of the target scene. The image 300 is generated from the sensor 102 of the imaging system, and each of the first and second portions of the image 300 have corresponding areas of the sensor 102, such that each pixel of the image 300 corresponds to a sensing element (or sensing elements) in the array of sensing elements of the sensor 102. The term “pixel” is used herein in reference to the images in FIGS. 3-5, and elsewhere as well, to generally indicate a point of data in an image and is used for ease of description, and should not be interpreted to as referring only to a portion of an image as displayed on an electronic computer screen.

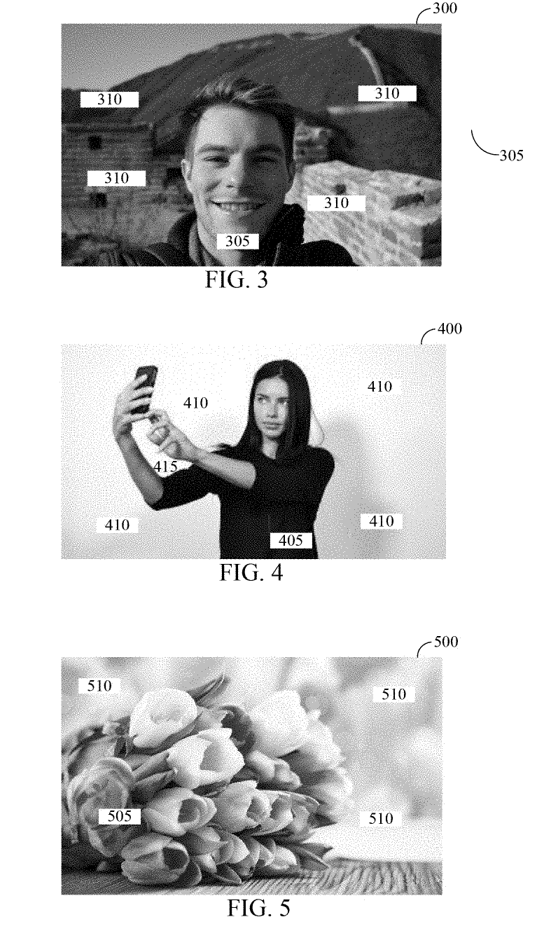

In a second example, FIG. 4 illustrates an image 400 that depicts a prominent subject 405 (a person) generally centered in the foreground of the image 400, and “flat” background imagery 410 (having a low dynamic range) behind the subject 405. It is noted that the image 400 includes a portion of background imagery 415 that is not contiguous with the other portions of background imagery 410. Also, the subject 405 includes portions that have a low dynamic range (appear generally to be dark or black). In a third example, FIG. 5 illustrates an image 500 that depicts a subject 505 (a bouquet of roses) positioned in the left and center portion of the image and in the foreground of the image, and out-of-focus imagery in the background 505 imagery behind the subject 505.

FIG. 6 is an example of a representation of the area of the image 300 shown in FIG. 3, illustrating segmentation and classification of the image 300 into a subject portion 605 and a background portion 610 of the image 300. The subject portion 605 and the background portion 610 refer to the locations on the image 300 that have been classified and segmented as a subject of the image 300 and background 610 of the image. The subject portion 605 and the background portion 610 may each be characterized by different image characteristics, which may affect the classification and segmentation. The subject portion 605 maybe characterized as, for example, being at a certain distance, a certain sharpness, or at a certain spatial location (e.g., generally centered) of the image 300. The background portion may be characterized by certain image characteristics, for example, having a smaller dynamic range than the subject portion and/or being more out-of-focus (less sharp) than the subject portion. The segmentation of the image 300 into the background and subject portions may then be used to generate image sensor control data indicating areas 905, 910, 915, 920, 925, and 930 (FIG. 9) corresponding to areas of the image sensor 102 to downscale certain portions of the image 300, which may be done either in the sensor 102 or in the image processor 104. In addition, the type of downscaling (e.g., vertical, horizontal) and the amount of downscaling (e.g., 2X, 4X, 8X, etc.) can also be determined. Sensor control information 131 indicative of the determined type of downscaling and the amount of downscaling can also be provided to the image sensor 102.

FIG. 7 is a representation of the area of the image 400 of FIG. 4, illustrating segmentation and classification of the image into a subject portion 705 and a plurality of “flat” portions 710, 715 (labeled “F” or “FLAT”), the flat portion of the image being characterized by having a dynamic range that is less, or substantially less, than the subject portion. In this example, some of the flat portions 715 are portions of the image that depict the subject 705, in this case the subject's dark shirt. Also, in this example, one of the flat portions 720 is a portion of the image that is in-between the subject's arms where the flat background area can be seen. In such cases, segmentation may determine whether or not to include such areas as a subject portion or a flat (that is, unimportant) portion. In some embodiments the size or shape of the area in question (e.g., flat portion 720) may be determined and compared to threshold values of size and/or shape (for example, area in number of pixels, bounding rectangle, largest rectangle enclosable in area, etc.). If the area is too small or if the size is not rectangular enough (as shown and further explained in the example of FIG. 9) the flat portion 720 will be included in the area of the subject 705. The flat portion 720 meets one or more of the criteria (for example, area in number of pixels, bounding rectangle, largest rectangle enclosable in area, etc.) then it may be designated as a flat area that should be downscaled. The segmentation of the image 400 into the background and subject portions may then be used to generate image sensor control data indicating areas 1005, 1010, 1015, 1020, 1025, and 1030 (FIG. 9) corresponding to areas of the image sensor 102 to downscale certain portions of the image 400.

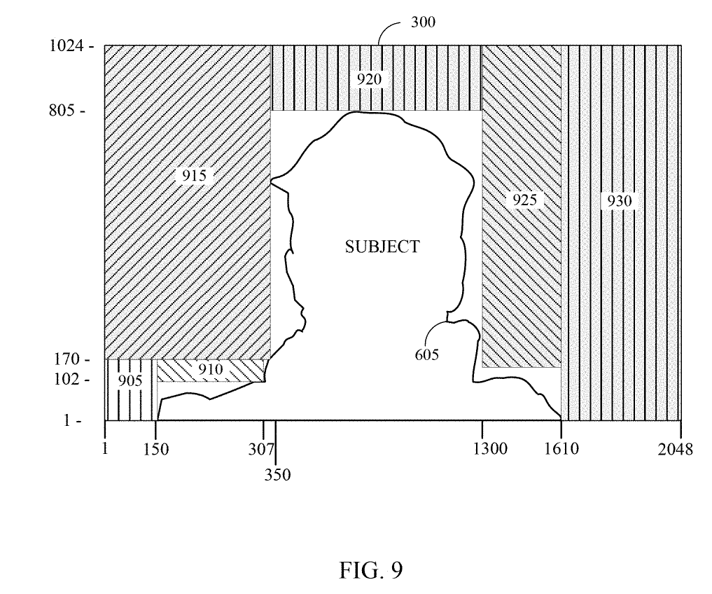

FIG. 8 is a representation of the area of the image shown in FIG. 5, illustrating segmentation and classification of the image into a subject portion 805 and an out-of-focus portion (that is, an unimportant portion) 810. In some embodiments, the out-of-focus portion 810 of the image is characterized by image data having smoother edge transitions than the subject portion 805.

FIG. 9 illustrates an example of determining control information to control how the image sensor 102 downscaling of portions of the image 300. FIG. 9 shows the portion of the image 300 associated with the subject 605, and the surrounding background. As part of the segmentation process, one or more rectangles are determined to cover all, or a portion of, the background portion of image 300. In some embodiments, image sensor control information 131 may include information indicating the areas of the rectangles and the downscaling to be performed, and the image sensor control information 131 can then be provided from the segmentation and classification module 108 (FIG. 1) to the image sensor 102. In some embodiments, the IP control input 133 provided from the classification and segmentation module 108 to the image processor 104 may include the similar, or the same, type of information that can be provided to the sensor 102 (e.g., indicating the areas of the rectangles and the downscaling to be performed) if the image processor is to perform the downscaling. In implementations where the image sensor 102 performs the downscaling and the image processor 102 performs the upscaling, the IP control input 133 may include information indicating what portions of the image were downscaled and what level and type of downscaling was performed by the image sensor 102 to control the image processor to upscale the image correspondingly to produce a properly scaled image. Based on the received image sensor control information, the sensor 102 downscales the image data generated by the imaging elements in the areas of the image sensor 102 that correspond with the rectangles and provides this in the image information 121 to the image processor 104 (FIG. 1). As illustrated in FIG. 1, the image information can also be provided from the image sensor 102 as an input 141 to the classification and segmentation module 108.

Still referring to FIG. 9, in this example, six rectangles 905, 910, 915, 920, 925, and 930 are determined to cover a portion of the background area. In FIG. 9, the numbers along the x-axis and y-axis correspond to imaging elements of an imaging sensor 102, in this representative example an imaging sensor 102 that is 1024 elements high by 2048 elements wide, these numbers and aspect being merely representative of the size and aspect of any image sensor 102. The six rectangles 905, 910, 915, 920, 925, and 930 can be described by opposite corners of the rectangles, for example, the top right (x, y) coordinate of the corner of the rectangle, and bottom left (x, y) coordinate of the corner of the rectangle. In this example, the six rectangles can be described as follows:
rectangle 905: (1, 170), (150, 1)
rectangle 910: (151, 170), (307, 102)
rectangle 915: (1, 1024), (350, 171)
rectangle 920: (351, 1024), (1300, 805)
rectangle 925: (1301, 1024), (1610, 170)
rectangle 930: (1611, 1024), (2048, 1)

This rectangle information may be provided to the image sensor 102 in any format necessary such that the image sensor 102 performs downscaling in the determined portions of the image data, in response to receiving the information. For example, information representative of the rectangles can be provided in the following representative format:
[# of rect's][rect 1(x,y)(x,y)][type][amount][rect 2 (x,y)(x,y)][type][amount] . . .

For example: for two rectangles, rectangle 905 with vertical downscaling at 2×, and rectangle 910 with vertical downscaling at 4×, a representative format may be:
[2][1,170,150,1][v][2][151,170,307,102][v][4]

A person of ordinary skill in the art will appreciate that the above format is merely representative of a possible format, many different types of formats may be used for the sensor control information, and the format of the sensor control information may depend on the configuration of the sensor 102.

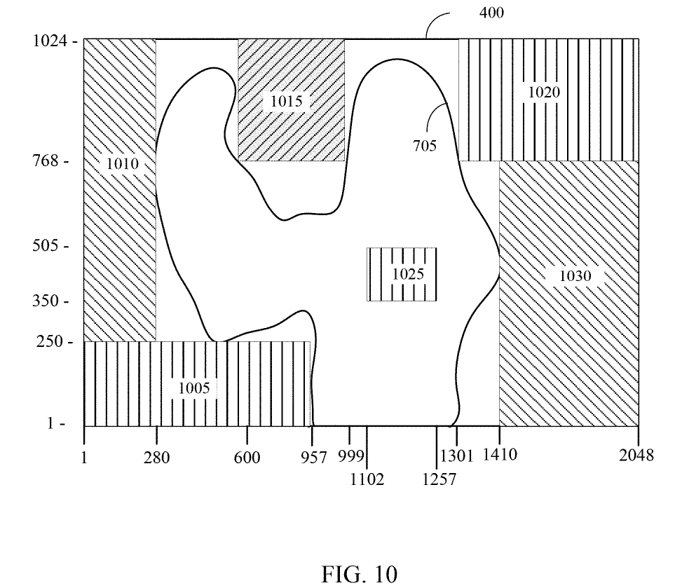

FIG. 10 illustrates an example of rectangular areas covering most of the background portion of the image illustrated in FIG. 4, the rectangular areas representing portions of the background which may be determined to be downscaled, and which control information is provided to the image sensor to downscale image data that is captured by the image sensor by sensing elements on the sensor corresponding to the rectangular areas. In this example, six rectangles 1005, 1010, 1015, 1020, 1025, and 1030 are determined to cover a portion of the background area. In FIG. 10, the numbers along the x-axis and y-axis correspond to imaging elements of an imaging sensor 102, in this representative example an imaging sensor 102 that is 1024 elements high by 2048 elements wide, these numbers and aspect being merely representative of the size and aspect of any image sensor 102. Similar to the rectangles described in reference to FIG. 9, the six rectangles 1005, 1010, 1015, 1020, 1025, and 1030 can be described by opposite corners of the rectangles, for example, the top right (x, y) coordinate of the corner of the rectangle, and bottom left (x, y) coordinate of the corner of the rectangle. In this example, the six rectangles can be described as follows:
rectangle 1005: (1, 250), (957, 1);
rectangle 1010: (1, 1024), (280, 251)
rectangle 1015: (600, 1024), (999, 768)
rectangle 1020: (1301, 1024), (2048, 768)
rectangle 1025: (1102, 505), (1257, 350)
rectangle 1030: (1410, 767), (2048, 1)
   Similar to described above for FIG. 9, this rectangle information may be provided to the image sensor 102 in any format necessary such that the image sensor 102 performs downscaling in the determined portions of the image data, in response to receiving the information.

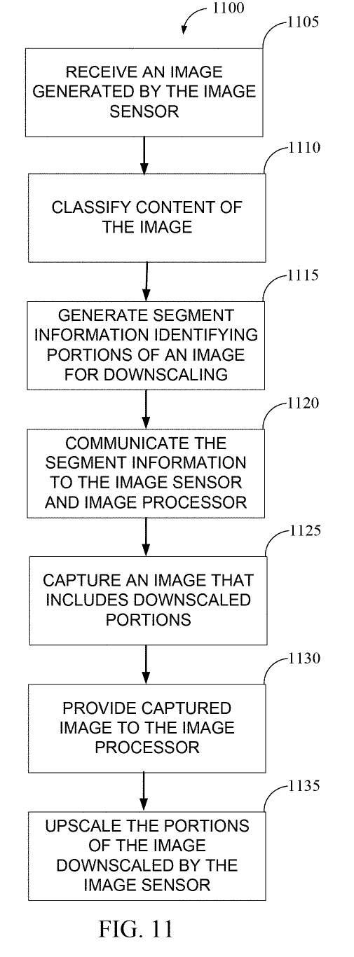

FIG. 11 illustrates a process 1100 for processing image data that can reduce consumption of the imaging device and increase image data throughput of the image device, according to some embodiments. At block 1105, the process 1100 receives at a processor an image generated by an image sensor. Note that although referred to here as “an image” for ease of reference, in operation there is a sequence of images captured which may be provided to a display for viewing and/or processed as video data. This is illustrated and described, for example, in reference to the classification and segmentation module 108 of FIG. 1A. At block 1110, a processor classifies content of the image based on predetermined criteria to identify candidate portions of the image for downscaling. This is further described, for example, in reference to FIG. 2 and FIGS. 3-10. At block 1115, the process 1100 generates segment information that includes one or more of the candidate portions, the segment information identifying portions of the image for downscaling by an image sensor and/or downscaling by an image processor, for example, image sensor 102 and image processor 104 (FIG. 1A). This is further described, for example, in reference to FIG. 2 and FIGS. 6-10. At block 1120, the process 1100 communicates the segment information to the image sensor and to the image processor to control downscaling at the sensor and/or the image processor, and subsequent upscaling by the image processor. At block 1125 the process 1130 captures an image of a target scene using the image sensor. The captured image includes portions of image data that is downscaled in response to the segment information provided to the image sensor. At block 1130, the process provides the captured image from the image sensor to the image processor. And at block 1130, and the process 1100 upscales the portions of the image that were downscaled by the image sensor responsive to the segment information received. This process may be repeated as a plurality of images are provided to a display for viewing or are captured as a “still” image or as video data.

### Implementing Systems and Terminology

Implementations disclosed herein provide systems, methods and apparatus for compact stereoscopic imaging systems. One skilled in the art will recognize that these embodiments may be implemented in hardware, software, firmware, or any combination thereof.

In some embodiments, the circuits, processes, and systems discussed above may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, one or more image signal processors, a memory including instructions or modules for carrying out the processes discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. The phrase “based on” does not mean “based only on,” unless expressly specified otherwise. In other words, the phrase “based on” describes both “based only on” and “based at least on.”

The previous description of the disclosed implementations is provided to enable any person skilled in the art to make or use the present invention. Various modifications to these implementations will be readily apparent to those skilled in the art, and the generic principles defined herein may be applied to other implementations without departing from the scope of the invention. Thus, the present invention is not intended to be limited to the implementations shown herein but is to be accorded the widest scope consistent with the principles and novel features disclosed herein.

What is claimed is:

1. An imaging device comprising:
an image sensor having an array of imaging elements and readout circuitry for generating image information of a target scene, the image information comprising at least first and second image information, the image sensor configured to
generate first image information of a first spatial resolution, the first image information including image data corresponding to a pixel values generated by a first portion of the array of imaging elements, and
generate second image information of a second spatial resolution, the second image information including image data corresponding to pixel values generated by a second portion of the array of imaging elements, the second spatial resolution being less than the first spatial resolution,
wherein the image sensor is further configured to control the downscaling of the spatial resolution of portions of the array of imaging elements responsive to received downscaling control information;
a memory component; and
a processor coupled to the memory component, the processor configured to
receive an image of the target scene and classify content of the image based on predetermined criteria to identify candidate portions of the image for downscaling,
determine downscaling control information for the candidate portions that for controlling downscaling of an image generated by the image sensor, and
provide the downscaling control information to the image sensor.

2. The imaging device of claim 1, wherein the image received by the processor is based on image data in the first image information and the second image information generated by the image sensor.

3. The imaging device of claim 1, wherein the second image information includes meta-data identifying the downscaling of the image data in the second image information.

4. The imaging device of claim 1, wherein the image sensor is further configured to control downscaling of the second image information using the downscaling control information.

5. The imaging device of claim 1, wherein the image sensor is configured to perform vertical binning to generate the second image information responsive to the downscaling control information.

6. The imaging device of claim 1, further comprising an image processor in electronic communication with the image sensor and the processor, the image processor configured to
receive the first and second image information from the image sensor,
upscale the image data in the second image information, and
provide the image to the processor.

7. The imaging device of claim 6, wherein the image information includes meta-data identifying the downscaling performed by the image sensor, and wherein the image processor is configured to upscale the image data in the second image information based on the meta-data.

8. The imaging device of claim 6, wherein the image processor is in electronic communication with the processor, and wherein the image processor is configured to receive an IP control input from the processor and upscale the image data in the second image information based on the IP control input.

9. The imaging device of claim 6, wherein the image processor comprises one or more filters configured to upscale the image data in the second image information.

10. The imaging device of claim 6, wherein the processor is further configured to provide an IP control input to the image processor, the IP control input identifying image processing operations for the image processor to perform on image data received from the image sensor.

11. The imaging device of claim 8, wherein the image processor is configured to, responsive to the IP control input, downscale portions of image data received from the image sensor and subsequently upscale the downscaled portions.

12. The imaging device of claim 10, wherein the IP control input includes information that identifies portions of image data to upscale.

13. The imaging device of claim 1, wherein the predetermined criteria includes a dynamic range threshold value to identify portions of the content of the image that have a small range of pixel values.

14. The imaging device of claim 1, wherein the predetermined criteria includes a sharpness threshold to identify portions of the content of the image that includes un-sharp pixel values.

15. The imaging device of claim 1, wherein the predetermined criteria includes a contrast threshold to identify portions of the content of the image that includes pixel values indicative of out-of-focus image data content.

16. The device of claim 1, wherein the predetermined criteria includes a contrast threshold for identifying subject and background portions of the content of the image.

17. A method of processing image data, the method comprising:
receiving, by an electronic hardware processor, an image of a target scene that is generated at least in part by an image sensor;
classifying, by the electronic hardware processor, content of the image based on predetermined criteria to identify candidate portions of the target scene for downscaling;
generating, by the electronic hardware processor, downscaling control information that identifies one or more of the candidate portions of the target scene for downscaling by the image sensor;
communicating the downscaling control information from the electronic hardware processor to the image sensor; and
generating image information of the target scene by the image sensor based on the downscaling control information, the image information comprising
first image information of a first spatial resolution, the first image information including image data corresponding to pixel values generated by a first portion of the array of imaging elements, and
second image information of a second spatial resolution, the second image information including downscaled image data corresponding to pixel values generated by a second portion of the array of imaging elements, the second spatial resolution being less than the first spatial resolution.

18. The method of claim 17, wherein the image of the target scene received by the processor is based on image information generated by the image sensor.

19. The method of claim 17, wherein the second image information includes meta-data identifying the downscaled image data in the second image information.

20. The method of claim 17, wherein generating the image information includes performing vertical binning to generate the second image information.

21. The method of claim 17, further comprising
receiving, at an image processor, the first and second image information from the image sensor;
upscaling the image data in the second image information at the image processor; and
providing, from the image processor, the image of the target scene to the electronic hardware processor.

22. The method of claim 21, wherein the image information includes meta-data identifying downscaling performed by the image sensor, and wherein upscaling the image data in the second image information is based on the meta-data.

23. The method of claim 21, wherein the image processor is in electronic communication with the electronic hardware processor, and the method further comprises receiving at the image processor an IP control input from the electronic hardware processor, and upscaling the image data in the second image information based on the IP control input.

24. The method of claim 23, wherein the IP control input includes information that identifies portions of a target scene to image data to upscale.

25. The method of claim 23, further comprising, at the image processor and responsive to the IP control input, downscaling portions of the image information image and subsequently upscaling the downscaled portions.

26. The method of claim 17, wherein the predetermined criteria includes at least one of a dynamic range threshold value for identifying portions of the content of the image that have a small range of pixel values, contrast threshold for identifying portions of the content of the image that includes pixel values indicative of out-of-focus image data content, or a sharpness threshold for identifying portions of the content of the image that includes un-sharp pixel values.

27. The method of claim 17, further comprising generating the image data of the second image information by performing vertical binning on the image sensor.

28. A non-transitory computer readable medium comprising instructions that when executed cause an electronic hardware processor to perform a method of image collection at an image sensor, the method comprising:
receiving, by the electronic hardware processor, an image of a target scene that generated at least in part by an image sensor comprising an array of imaging elements;
classifying, at the electronic hardware processor, content of the received image based on predetermined criteria to identify candidate portions of the target scene for downscaling;
generating, by the electronic hardware processor, downscaling control information that identifies one or more of the candidate portions of the target scene for downscaling by the image sensor; and
communicating the downscaling control information from the electronic hardware processor to the image sensor for use by the image sensor to capture image information of the target scene, the image information including first image information of a first spatial resolution, the first image information including image data corresponding to pixel values generated by a first portion of the array of imaging elements, and second image information of a second spatial resolution, the second image information including downscaled image data corresponding to pixel values generated by a second portion of the array of imaging elements, the second spatial resolution being less than the first spatial resolution.

29. The non-transitory computer readable medium of claim 28, wherein the method further comprises generating an IP control input at the electronic hardware processor and providing the IP control input to an image processor, the IP control input including information for use by the image processor to upscale the image data of the second image information.

30. A method of processing image data, the method comprising:
receiving, at an electronic hardware processor from an image processor, an image of a target scene that was captured by an image sensor;
classifying, by the electronic hardware processor, content of the image based on predetermined criteria to identify portions of the target scene for downscaling;
generating, by the electronic hardware processor, downscaling control information that indicates one or more portions of the target scene for downscaling by the image sensor;
providing the downscaling control information to the image sensor;
generating, by the image sensor, image information of the target scene based on the downscaling control information, the image information comprising
first image information of a first spatial resolution, the first image information including image data corresponding to pixel values generated by a first portion of the array of imaging elements, and
second image information of a second spatial resolution, the second image information including downscaled image data corresponding to pixel values generated by a second portion of the array of imaging elements, the second spatial resolution being less than the first spatial resolution;
providing the image information to the image processor; and
upscaling the image data of the second image information, at the image processor.
